(19) United States
(12) Patent Application Publication
(10) Pub. No.: US 2015/0026760 A1
(43) Pub. Date: Jan. 22, 2015

(54) System and Method for Policy-Based Confidentiality Management

(71) Applicant: Keith Lipman, Bala Cynwyd, PA (US)

(72) Inventor: Keith Lipman, Bala Cynwyd, PA (US)

(21) Appl. No.: 14/335,857

(22) Filed: Jul. 18, 2014

Related U.S. Application Data
(60) Provisional application No. 61/856,691, filed on Jul. 20, 2013.

(51) Int. Cl. G06F 21/62; H04L 29/06

(52) U.S. Cl. CPC G06F 21/6218; H04L 63/20
USPC 726/1

(57) ABSTRACT

A system and method for policy-based confidentiality management provides comprehensive, fluid management of information security and ethical walls. It streamlines processes for securing confidential information without creating productivity barriers, provides interfaces to securely support processes of each major audience in a professional service organization across multiple systems and allows a Risk Team to create policy types for different scenarios and identify systems affected by the policies. It supports standard policy types and those for lateral hires, ITAR, data privacy, price sensitivity, trade secrets, and conflicts of interest and provides two-stage review to prevent incorrect policy application. User interfaces allow granting, denying, and requesting access. Reports sort information governance policies by user/group, client/engagement, or policy type. The system prevents both service desk and other professionals from violating risk management policies in the first place and provides a common user experience, whether a wall has an information barrier or is confidential.

### CROSS-REFERENCE TO RELATED APPLICATIONS

This application claims benefit of U.S. provisional patent application Ser. No. 61/856,691, filed on Jul. 20, 2013, which is incorporated herein in its entirety by this reference thereto.

### BACKGROUND

1. Technical Field

The invention generally relates to the field of computerized information governance. More particularly, the invention relates to a system and method for policy-based confidentiality management.

2. Background Information

An aspect of business process management that is steadily growing in importance, particularly in professional service organizations such as law firms, is information governance. Data privacy and data security are in the news constantly. Hardly a day passes that one does not hear of some new security breach in which hundreds of thousands of credit card numbers or Social Security numbers have been misappropriated. Organizations such as retailers and hospitals are being required to formulate and publish privacy policies and there have been a number of government initiatives that concern the proper use and safeguarding of personally-identifiable information (PII).

For example, in the United States, the Health Insurance Portability and Accountability Act (HIPAA) was originally implemented in 1996. One of the chief aims of HIPAA is to protect the confidentiality and security of healthcare information. The primary tools through which HIPPAA does this are the Privacy Rule, which establishes national standards to protect individuals' medical records and other personal health information, and the Security Rule, which details administrative, physical and technical safeguards required to ensure confidentiality, integrity, and security of electronic protected health information. Any professional service organization that manages personal health information is subject to the HIPAA rules.

The Gramm-Leach-Bliley Act requires financial institutions—companies that offer consumers financial products or services like loans, financial or investment advice, or insurance—to explain their information-sharing practices to their customers and to safeguard sensitive data.

There have been a number of privately-sourced initiatives as well.

For example, the Payment Card Industry Data Security Standards (PCI-DSS), developed by the founders of the PCI Security Standards Council, includes requirements for security management, policies, procedures, network architecture, software design and other critical protective measures.

One of the most well-known privately-sourced initiatives is ISO 27001, an independently-developed information security management framework that is being widely adopted among business, industry and professional service organizations.

Compliance with these standards and initiatives imposes a formidable administrative burden on businesses and professional service organizations, and the consequences of failure to comply are often dire. For example, HIPAA violations can incur significant civil and even criminal sanctions.

In addition to compliance issues, professional firms also face higher expectations from their clients and customers to provide a high level of security and confidentiality for sensitive data and information in the firms' possession. Law firms, for example, store some of their clients' most sensitive business information, and clients are starting to mandate more and more stringent requirements for outside counsel information security practices. In fact, firms may even be subject to surprise audits from clients to verify compliance with agreed-on measures and practices.

Law firms also face the challenge of implementing and maintaining ethical walls, for example, in the case of a lateral hire which has triggered conflict-of-interest rules. Conventionally, such barriers have been implemented procedurally, via office memos, restriction of access to physical records, and reliance on the ethical diligence of professionals and administrative staff. However, so much data is now stored electronically that ethical walls must now extend to most or all of a firm's systems. Furthermore, codes of conduct and legal precedent expressly require electronic management with thorough audit trails.

Military and espionage organizations have long relied on “need to know” restriction of access to sensitive data as a means of preventing unauthorized access and use of the data without inconveniencing legitimate access—limiting risk by limiting access.

Increasingly, companies and professional service organizations are turning to such practices as part of their information security practices. Often, however, need-to-know policies are implemented in an ad hoc fashion and, thus, are of limited effectiveness. Additionally, switching from an open-access model, in which all employees in an organization are given unlimited access to all of a firm's data, to a need-to-know model can be extremely disruptive to a firm's day-to-day activities, frustrating the professional staff and greatly limiting their effectiveness as a result of IT bottlenecks.

### SUMMARY

A system and method for policy-based confidentiality management provides comprehensive, fluid management of information security and ethical walls. It streamlines processes for securing confidential information without creating productivity barriers, provides interfaces to securely support processes of each major audience in a professional service organization across multiple systems and allows a Risk Team to create policy types for different scenarios and identify systems affected by the policies. It supports standard policy types and those for lateral hires, ITAR, data privacy, price sensitivity, trade secrets, and conflicts of interest and provides two-stage review to prevent incorrect policy application. User interfaces allow granting, denying, and requesting access. Reports sort information governance policies by user/group, client/engagement, or policy type. The system prevents both service desk and other professionals from violating risk management policies in the first place and provides a common user experience, whether a wall has an information barrier or is confidential.

The features and advantages described in this summary and in the following detailed description are not all-inclusive, and particularly, many additional features and advantages will be apparent to one of ordinary skill in the relevant art in view of the drawings, specification, and claims hereof. Moreover, it should be noted that the language used in the specification has been principally selected for readability and instructional purposes, and may not have been selected to delineate or circumscribe the inventive subject matter, resort to the claims being necessary to determine such inventive subject matter.

### BRIEF DESCRIPTION OF THE DRAWINGS

FIG. 1 is a block diagram of an exemplary network architecture in which a policy-based confidentiality management system may be implemented;

FIG. 2 is a block diagram of a computer system suitable for implementing a policy-based confidentiality management system;

FIG. 3 provides a diagram of a system architecture for policy-based confidentiality management;

FIG. 4 provides a diagram of a workflow for defining a confidentiality policy;

FIGS. 5A and 5B provide separate views of a user interface for defining a policy type;

FIGS. 6-7 show forms for defining a security policy for a highly confidential matter;

FIGS. 8-9 show forms for notifying a user of his or her inclusion on matter team according to police and for managing user acknowledgements of the policy notification;

FIG. 10 shows a form for displaying a listing of the team members associated to a matter;

FIG. 11 shows a Security Center record for a matter, which clearly displays the security policy in place for the matter; and

FIG. 12 shows a workflow for managing self-service requests

FIG. 13 shows a searchable log of self-service requests that reports the status of each request;

FIG. 14 shows a form for defining a self-service request; and

FIG. 15 shows an email form for informing an approving authority of the submission of a self-service request.

### DETAILED DESCRIPTION

A system and method for policy-based confidentiality management provides comprehensive, fluid management of information security and ethical walls. It streamlines processes for securing confidential information without creating productivity barriers, provides interfaces to securely support processes of each major audience in a professional service organization across multiple systems and allows a Risk Team to create policy types for different scenarios and identify systems affected by the policies. It supports standard policy types and those for lateral hires, ITAR, data privacy, price sensitivity, trade secrets, and conflicts of interest and provides two-stage review to prevent incorrect policy application. User interfaces allow granting, denying, and requesting access. Reports sort information governance policies by user/group, client/engagement, or policy type. The system prevents both service desk and other professionals from violating risk management policies in the first place and provides a common user experience, whether a wall has an information barrier or is confidential.

Law firms and other professional service organizations are facing ongoing pressure to move from a model where access to most matter or engagement-related data in the organization is available to all other members of the organization (e.g. a public security model) to one in which access to information is limited to those who are working on the matter or engagement. Two fundamental issues are driving this change (1) state-sponsored, political, and economic hacking that is now occurring in the world and (2) change or enforcement of privacy rules throughout the world.

However, when information is secured so that only users of who are working on a matter may access information related to the matter, many fundamental information sharing workflows may break down. The areas of breakdown may include:
How lawyers and professionals work with assistants in drafting documents;
How lawyers and professionals work with temporary secretaries and document processing centers;
How a lawyer, paralegal or other professional obtains access to a matter; and
How a lawyer or other professional finds exemplars and other materials.

Law firms and other professional service organizations also need to consider conflicts of interest. When a conflict of interest arises, the firm is usually required to exclude a conflicted user from accessing information about a relevant matter or engagement. The exclusion may occur over one or a few matters and may even include all of the matters for a client.

### Policy Enforcement Taking Over Basic Functions of Other Systems

The challenge with ethical wall enforcement in subsidiary systems, such as document management systems, is that they have done the enforcement through a back-end process. For example, if a user saves a document and he or she removes a group or user that has been placed on the document through the policy enforcement process, the policy enforcement system then needs to heal the security breach through the re-application of the user or group. Similarly, for a new document, the policy enforcement system may validate after the document has been saved that the document correctly follows the policy. The challenge with this approach, however, is that the user typically does not have feedback on the policy and may have violated it, the result being a breach of the policy.

Instead, policy feedback may be provided at the time of saving the document, preventing breaches from happening. This can also include:
Preventing a user from securing content to a narrower group of individuals if the person does not have heightened privileges; for example, having the status of Matter Owner.
This same functionality may occur when using email, so that policy feedback is provided at the moment of sending an email to the system. The feedback provided may include:
   The system should grant access to the document when a user sends an email.
   Preventing a user from sending or emailing a document to an excluded individual.

Described herein below is a system and method for policy-based confidentiality management—a system to support an organization where most information has been secured to those who need access.

In embodiments, the system has the capability to create policy templates. The policy templates may be used to determine the type of security to be applied. The systems may be secured with the policy and may provide the user the ability to gain access to the matter through a self-service request. The type of security may include: confidential, exclusion, contractor, and competitive security:
“Confidential” means that only certain users have been granted access;
“Exclusion” means that certain users can not have access;
“Contractor” means that certain users can only have access to specific matters;
“Competitive” means that a user is excluded from work for another client or matter;
   “If you do work for company A, you cannot do work for company B.”

In the policy template, the firm may define an ability for a user to gain access to a secured matter through a self-service function. The self-service function allows an end user to request access. As a result of the request, an email may be sent to the appropriate approving authority to request approval, or the user may be given automatic access. Approval criteria may include:
Anyone—allows anyone to be granted access upon request;
Approval of matter owner—requires the matter owner to approve any request for access;
Approval of Matter Team—any member of the matter team may receive notice and grant access;
Approval of Risk Team—only the Risk Team may receive notice and may approve the request for access;
No Self-Service permitted—requires the Risk Team to grant access only through the system's policy interface.

### Additional Policy Template Features:

The ability to prevent access;
Confidential access can be used to provide:
   A restriction to the team of people who specifically need access to the matter;
   Ring security to make the information access limited to only certain group to support data privacy or practice standards; and
   Ring security can also be used to provide containment that will limit those who can potentially be provided access to a matter or engagement.
Policies can be based upon:
   Client;
   Matter or engagement;
   Department or Office.
Client, Department and Office policies may provide a base set of rules that serve as stamps or templates.
The system supports the ability for notification through email for any person who is either being excluded or included in a matter or client. The notification may require the user to acknowledge the notice:
   For confidential matters, the policy may require the user to acknowledge the notice before granting the user access.

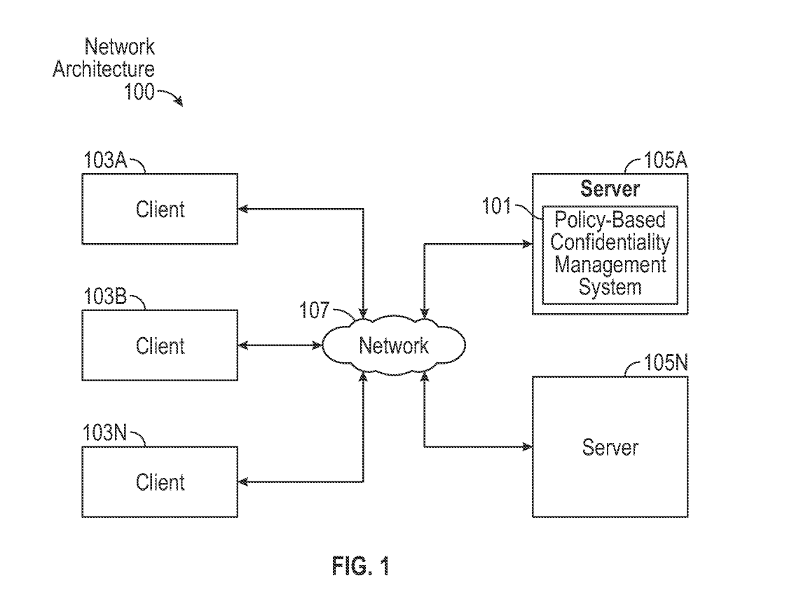

FIG. 1 is a block diagram illustrating an exemplary network architecture 100 in which a policy-based confidentiality management system 101 may be implemented. The illustrated network architecture 100 comprises multiple clients 103A, 103B and 103N, as well as multiple servers 105A and 105N. In FIG. 1, the policy-based confidentiality management system 101 is illustrated as residing on server 105A. It is to be understood that this is an example only, and in various embodiments various functionalities of this system 101 may be instantiated on a server 105, a client 103, or may be distributed between multiple clients 103 and/or servers 105.

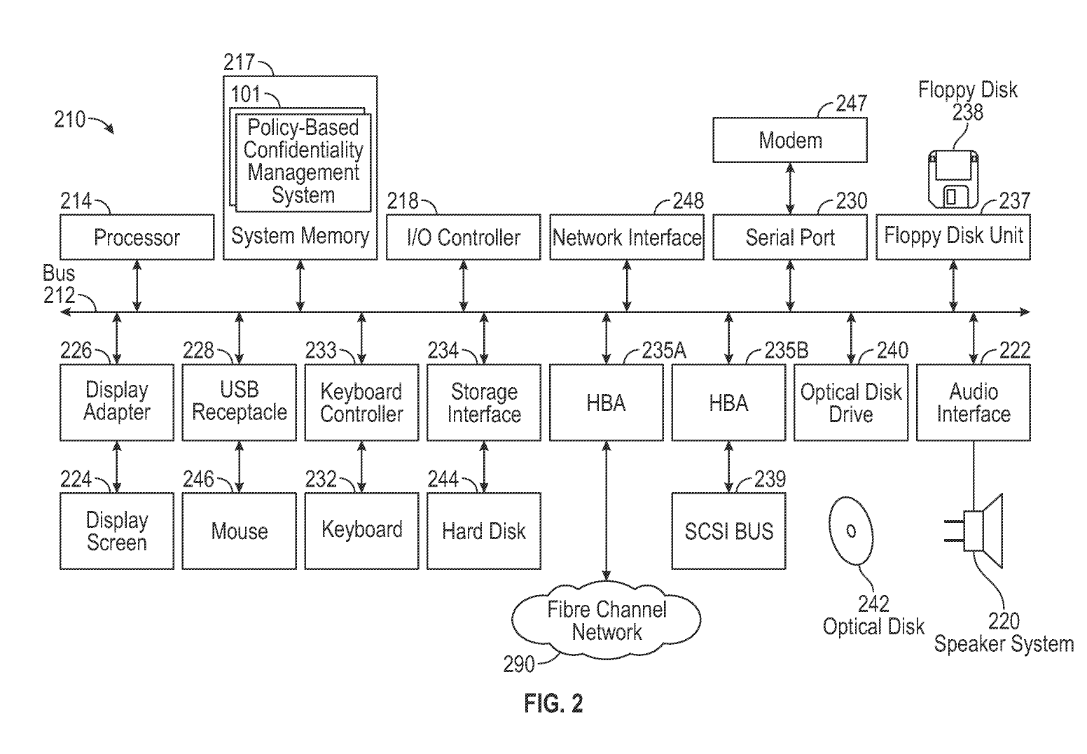

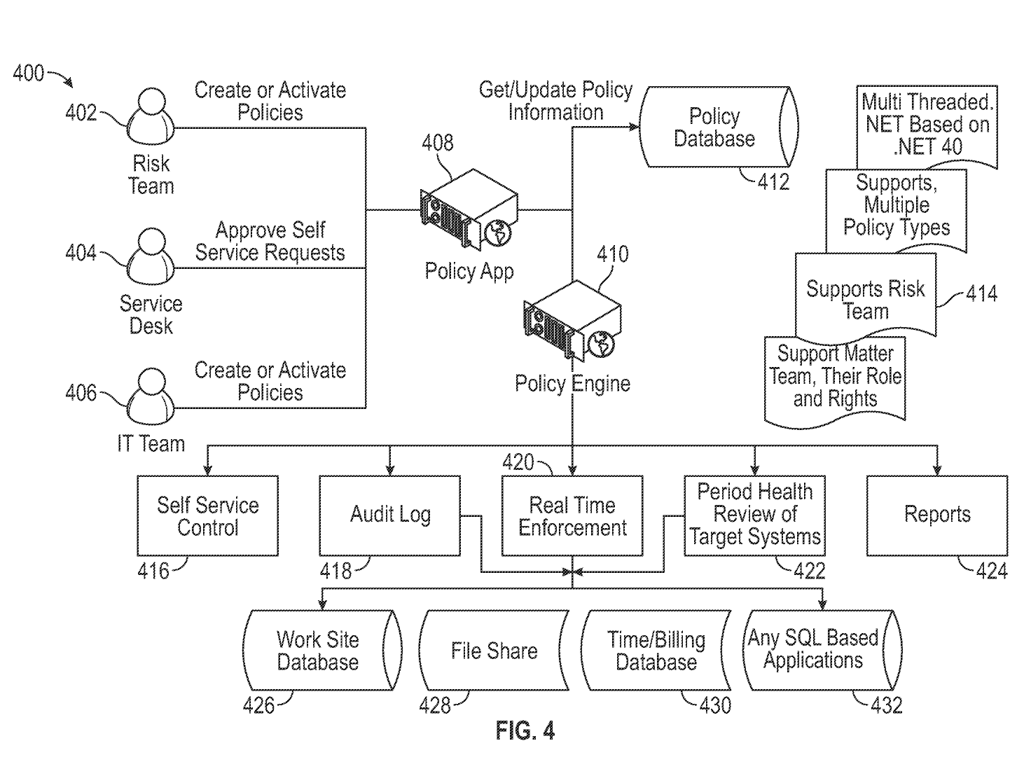

Clients 103 and servers 105 may be implemented using computer systems 210 such as the one illustrated in FIG. 2 and described below. The clients 103 and servers 105 are communicatively coupled to a network 107, for example via a network interface 248 or modem 247 as described below in conjunction with FIG. 2. Clients 103 are able to access applications and/or data on servers 105 using, for example, a web browser or other client software (as shown in FIG. 4). Clients 103 may, but need not, be in the form of mobile computing devices, comprising portable computer systems 210 capable of connecting to a network 107 and running applications. Such mobile computing devices are sometimes referred to as smartphones, although many mobile phones not so designated also have these capabilities. Tablet computers are another example of mobile computing devices.

Although FIG. 1 illustrates three clients 103 and two servers 105 as an example, in practice many more (or fewer) clients 103 and/or servers 105 may be deployed. In one embodiment, the network 107 may be in the form of the Internet. Other networks 107 or network-based environments may be used in other embodiments.

FIG. 2 is a block diagram of a computer system 210 suitable for implementing a policy-based confidentiality management system 101. Both clients 103 and servers 105 may be implemented in the form of such computer systems 210. As illustrated, one component of the computer system 210 may be a bus 212. The bus 212 communicatively couples other components of the computer system 210, such as at least one processor 214, system memory 217 (e.g., random access memory (RAM), read-only memory (ROM), flash memory), an input/output (I/O) controller 218, an audio output interface 222 communicatively coupled to an external audio device such as a speaker system 220, a display adapter 226 communicatively coupled to an external video output device such as a display screen 224, one or more interfaces such as serial ports 230, Universal Serial Bus (USB) receptacles 230, parallel ports (not illustrated), etc., a keyboard controller 233 communicatively coupled to a keyboard 232, a storage interface 234 communicatively coupled to at least one hard disk 244 (or other form(s) of magnetic media), a floppy disk drive 237 configured to receive a floppy disk 238, a host bus adapter (HBA) interface card 235A configured to connect with a Fibre Channel (FC) network 290, an HBA interface card 235B configured to connect to a SCSI bus 239, an optical disk drive 240 configured to receive an optical disk 242, a mouse 246 (or other pointing device) coupled to the bus 212 e.g., via a USB receptacle 228, a modem 247 coupled to bus 212, e.g., via a serial port 230, and a network interface 248 coupled, e.g., directly to bus 212.

Other components (not illustrated) may be connected in a similar manner (e.g., document scanners, digital cameras, printers, etc.). Conversely, all of the components illustrated in FIG. 2 need not be present. The components may be interconnected in different ways from that shown in FIG. 2.

The bus 212 allows data communication between the processor 214 and system memory 217, which, as noted above may include ROM and/or flash memory as well as RAM. The RAM is typically the main memory into which the operating system and application programs are loaded. The ROM and/or flash memory may contain, among other code, the Basic Input-Output system (BIOS) which controls certain basic hardware operations. Application programs may be stored on a local computer readable medium (e.g., hard disk 244, optical disk 242) and loaded into system memory 217 and executed by the processor 214. Application programs may also be loaded into system memory 217 from a remote location (i.e., a remotely located computer system 210), for example via the network interface 248 or modem 247. In FIG. 2, the policy-based confidentiality management system 101 is illustrated as residing in system memory 217. The workings of the policy-based confidentiality management system 101 are explained in greater detail below in conjunction with the remaining Figures.

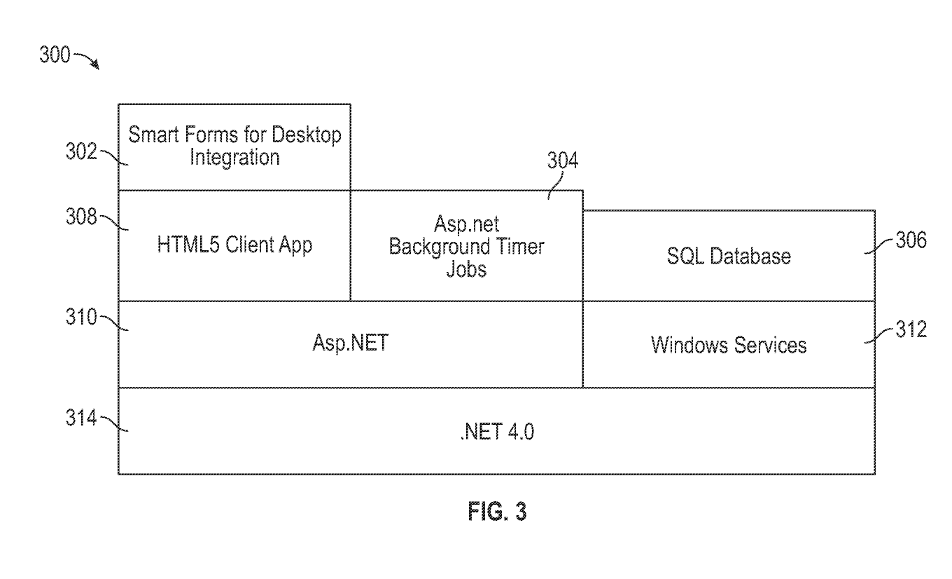

FIG. 3 provides a diagram of an exemplary architecture 300 upon which the policy-based confidentiality management system 101 may be implemented. In brief, the architecture 300 may include one or more of the following components:
.NET 4.0 (314)—The .NET framework is a development platform, which runs primarily on WINDOWS (Microsoft Corp, Redmond, Wash.), providing generic functionality that can be selectively modified using additional user-written code, to provide application-specific software;
Asp.NET (310)—Asp.NET is an open source server-side Web application framework designed for Web development to produce dynamic web pages. Asp.NET web pages, known conventionally as web forms, serve as the main building blocks for application development;
Windows services (312)—WINDOWS services are applications that run as background processes which usually have limited interaction with customary I/O and may be launched by the operating system (OS) at boot time. In more recent versions of WINDOWS, WINDOWS services can be configured and manually started and stopped through the Control Panel. An example of a WINDOWS service may be, for example, an application that writes data to an event log, a database server, an anti-virus engine, etc.
HTML5 client app (308)—client-side application written in HTML5 (hypertext markup language);
Asp.NET:Background Timer:Jobs (304)—There are situations wherein an application needs to execute code on a recurring basis, for example, to create a report, to send a reminder e-mail, to back up data, and so on. It is with a timer that these recurring tasks are scheduled and run according to the schedule;
SQL Databases (306)—databases that support the use of SQL to access their data. As described herein below, the system for policy-based confidentiality management includes at least a policy database. In addition, each of the systems with which the system interacts, for example the practice management system or the document management system includes at least one database; and
Smart Forms for desktop integration (302)—Smart Forms are electronic forms that have certain capabilities built into them, for example, performing calculations, displaying dynamic content, validating data and looking up data from remote systems.

The foregoing architecture is described only as an example. One of ordinary skill will readily understand that there may exist many possible combinations of many alternative building blocks to produce a system having the same or similar functional capabilities.

There are three critical audiences to any risk management system in a professional service organization:
The risk management team who needs to set policy and review certain organizational risks;
The end user who needs to work within the policies that have been established and actually acquire access to the information they need to actually get work done; and
The IT (information technology) organization, which is operative to provide service to end users and the Risk Team. Within the IT organization, there is typically a service desk that has the authority to grant users' requests for certain operations, such as a grant of access to a document, based upon a verbal authorization/policy or alternatively, to advise who has the authority to grant access.

Those tasked with defining policies for confidentiality management may be guided by the following security safeguard principles:
Define a confidentiality policy and make employees aware of it;
Identify confidential information within the firm and identify it as such;
Do not store confidential information where it is easily accessible by unauthorized persons;
Ensure communication of confidential information is by secure means, and that recipients know it should be treated as such;
Only disclose confidential information to employees or third parties where reasonably necessary.

Turning now to FIG. 4, shown is a workflow 400 for administering a system for policy-based confidentiality management, including creation, activation and editing of policies and approval of self-service requests. A policy engine 410 has a number of roles within the system 101. As shown, major roles and capabilities 414 of the policy engine 410 include:
Support for multiple policy types;
Supporting the Risk Team; and
Supporting the roles and rights of the members of the matter team.

In an embodiment, the matter engine 410 may be a multi-threaded application built on the .NET 4.0 framework. In an embodiment, the matter engine may be communicatively coupled to a policy database 412. In an embodiment, the policy database 412 provides storage for policy information in the form of individual policy records. The policy engine 410 may interact with the policy database 412 in updating and retrieving policy information.

In an embodiment, the policy engine 410 is communicatively coupled with at least one instantiation of a policy application 408. In an embodiment, the policy application is a client application through which end users, the Risk Team and the IT team interact with the system 101. In a typical usage scenario, the Risk Team, by means of the policy application 408, enters data to create or update a policy. The data constituting the created or updated policy entered by the Risk Team is received by the policy engine 410. Upon receiving the policy data, the policy engine stores the policy data in the policy database 412. Additionally, by way of the policy application 408, the policy engine may 410 receive requests for policy data so that the requestor can view the data, and possibly edit or update the data. Additionally, by way of the policy application, the policy engine may receive requests to activate previously-saved policies. As shown in FIG. 4, the IT team 406, within the system, also has authority to create or activate policies, thus, the interaction of the IT team 406 with the policy engine 410 via the policy app 408 may be considered a close analogue of the Risk Team's 402 interaction.

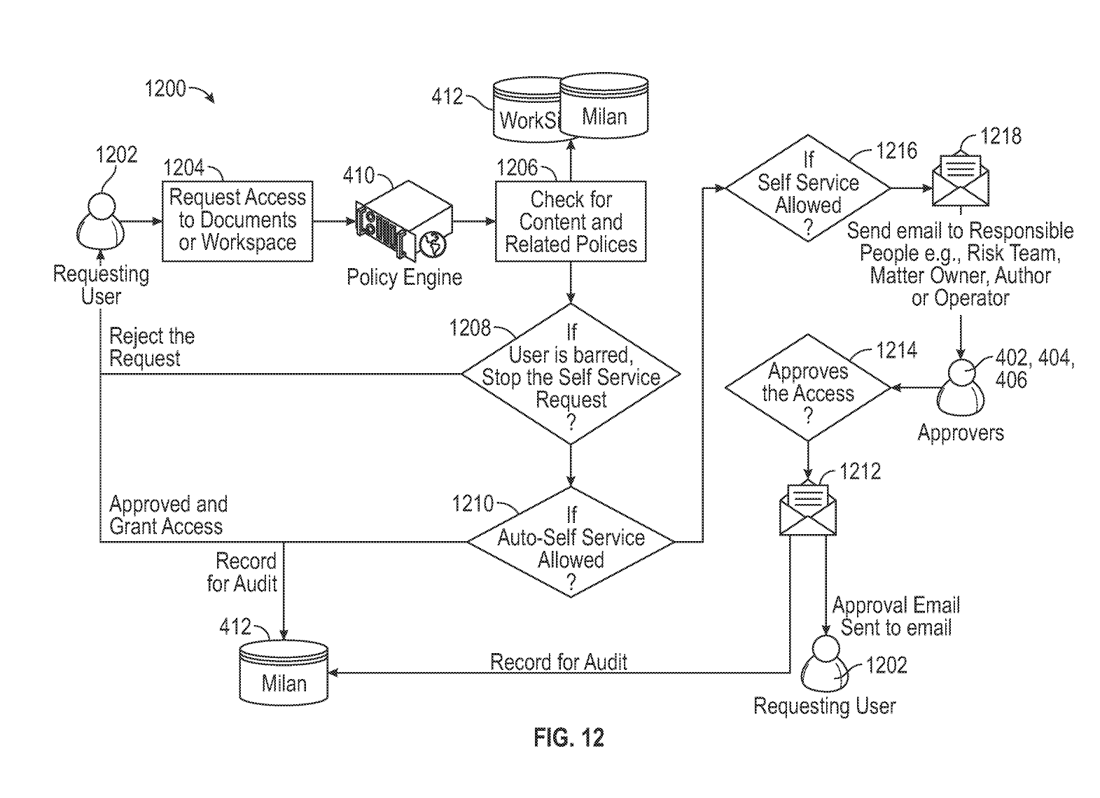

As shown in FIG. 4, the Service desk 404 may receive self-service requests. In an embodiment, as shown in FIG. 12, the self-service requests are typically originated by end users and routed to the policy engine 410, whereupon the requests are routed to the service desk for action. Via the policy application 408, actions on self-service requests are received at the policy engine 410 and directed to the originating end user.

An additional role of the policy engine 410 is real-time enforcement of policies among the various subsidiary systems found within the professional service organization, for example document management 426, file sharing 428, time and billing 430 and SQL-based applications 432. Policy enforcement by the policy engine is made possible by the ability of the policy engine to override the native security dialogue of the subsidiary systems and replace it with the dialogue native to the present system, the result of which is that the subsidiary systems respect the security policies associated to the new security dialogue.

Further functions of the policy engine 410 may include:
Self-service control 416;
Maintenance of an audit log 418;
Periodic health review of target systems 422; and
Reporting 424.

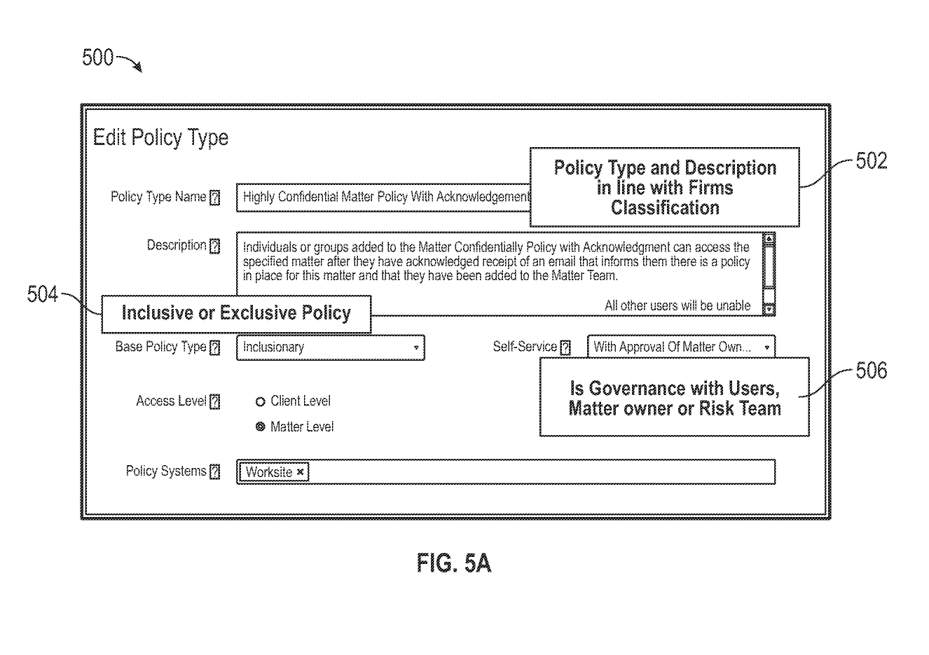

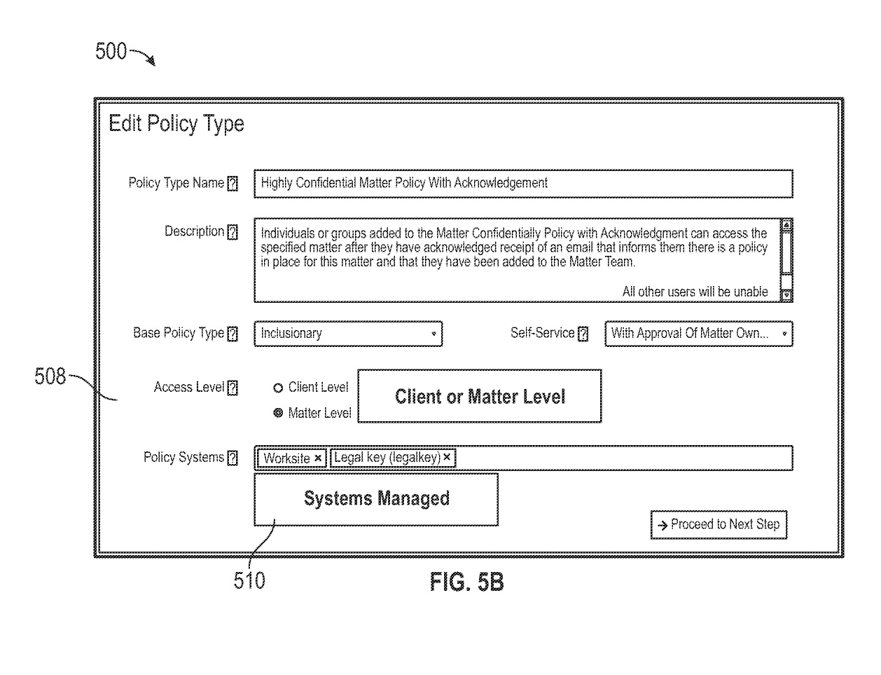

The process of defining a confidentiality policy may include one or more of the steps of:
Defining security classifications for matter and internal workspaces;
Defining governance and management; and
Communication of the policy.
   FIGS. 5A and 5B show a form for defining a policy type. Policy definition may involve the selection of a policy type 504. In selecting a policy type, a number of parameters may be configured.

The process of editing a policy type may involve one or more of the steps of:
Selecting a policy type and description in line with the organization's classification 502;
Determining whether the policy is to be inclusive or exclusionary 504;
Determining an access level: matter level or client level 508; and
Specifying which systems are to be managed, for example document and/or practice management.

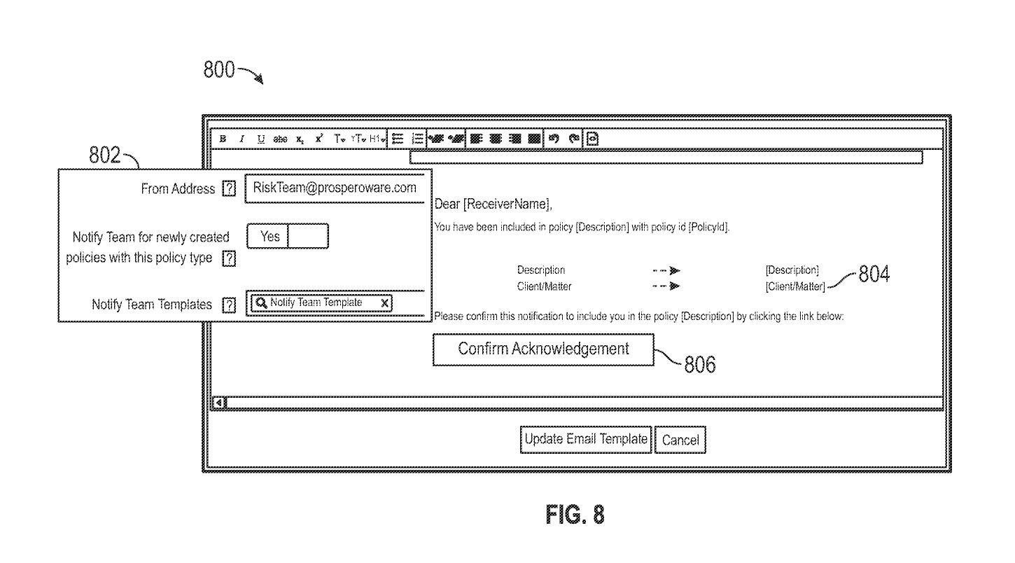

As shown in FIG. 5, a requirement to be included on a matter team may be that the person needs to be informed of their inclusion and acknowledge the notice of inclusion. FIG. 8 shows a template 800 from the user interface to the policy application 408 for creating an email notification informing a user of his/her inclusion on a matter team. The template 800 may include one or more fields 802 for, for example, identifying a sender and specifying that notification of matter team members needs to be made. The template may further include one or more fields 804 for entering a policy description and a client matter. Additionally, the email template may include an ‘acknowledge’ button 806, which simplifies the task of acknowledging the notification on the part of the recipient of the notice email.

As described above, an aspect of defining a policy involves the selection 504 of a policy type. A number of policy types are possible. A list of exemplary policy types may include, but may not be limited to:
Inclusive: identifies those who are granted access under the policy;
Exclusive: identifies those who are denied access (e.g. Lateral Hires);
Competitive: identifies those who are denied access owing to their work on another client or matter; and
Contractor: identifies those whose access is limited to a defined set of clients or matters

Matters can have multiple policies defined. The system doesn't allow contradictions. For example a user cannot be added to both inclusive and exclusive policies for the same matter. In addition, policies may have a hierarchic relationship to each other such that when more than one policy is applied to a matter, a policy defining more specific, more restrictive security settings takes precedence over a more general policy. Additionally, the enterprise system provides global, default security settings that are operative in the absence of a defined security policy. In the event that a security policy is subsequently applied to a matter, the setting defined in the policy, in most cases, takes precedence over the global security setting specified by the enterprise system.

### Highly Confidential Matter

In an embodiment, a Highly Confidential Matter scenario may include one or more of the following circumstances:
Involves matters with Highly Confidential information that would cause damage to the client or firm if the information was disclosed outside of the matter team;
Access to the matter can only be authorized by the Risk Team;
All matter team members must be sent details of the security policy, to which they must acknowledge before gaining access; and
All correspondence with the client must be encrypted and monitored.

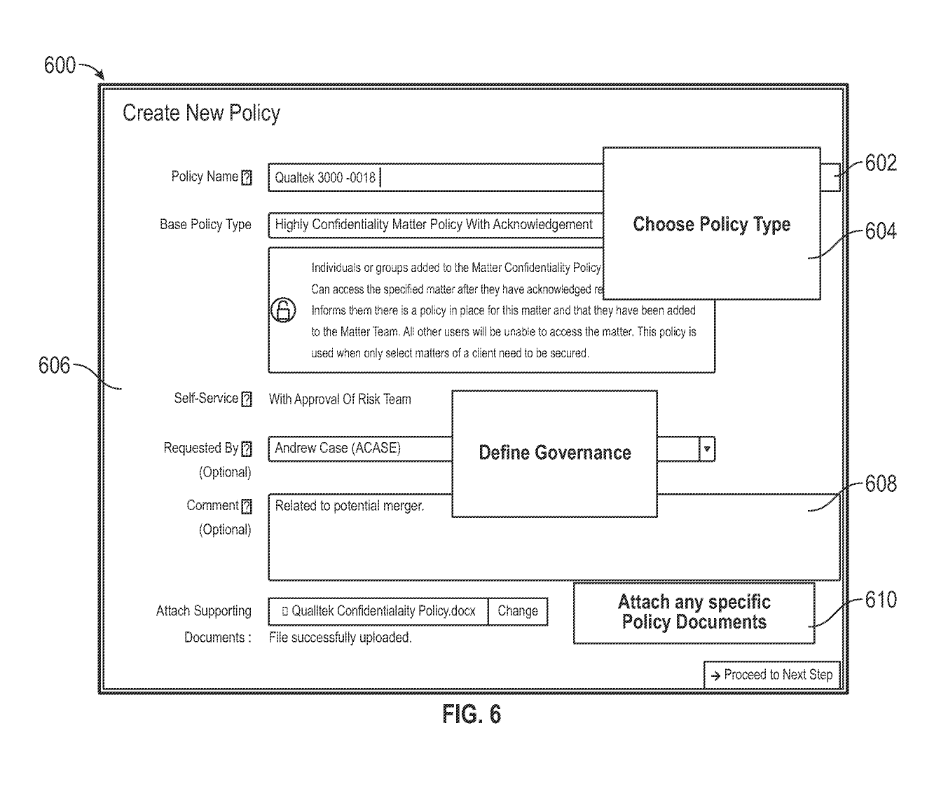

Referring next to FIG. 6, shown is a form 600 for defining a Highly Confidential Matter policy from the user interface to the policy application 408. As explained above in relation to FIG. 4, within the system 101, the Risk Team 402 and the IT team 406 typically may be tasked with authoring new policies via a form 600. Briefly, creating a new Highly Confidential Matter policy may involve at least one of the steps of:
Selecting a policy name 602;
Selecting a policy type 604;
Defining governance 608; and
Attaching supporting documentation 610.
As shown, self-service option 606 is automatically configured to require Risk Team approval
   In an embodiment, policy types 604 for a Highly Confidential Matter policy may include:
Executive Only: for Board Papers, Firm Strategy;
Highly Confidential: for Mergers, High Impact matters;
Confidential: for PI (personally identifiable information), PHI (personal health information);
Inclusions: The team members who are granted access;
Exclusions: Competitive, Lateral Hires.

In an embodiment, defining governance 608 may constitute defining who controls and/or who monitors authorization.

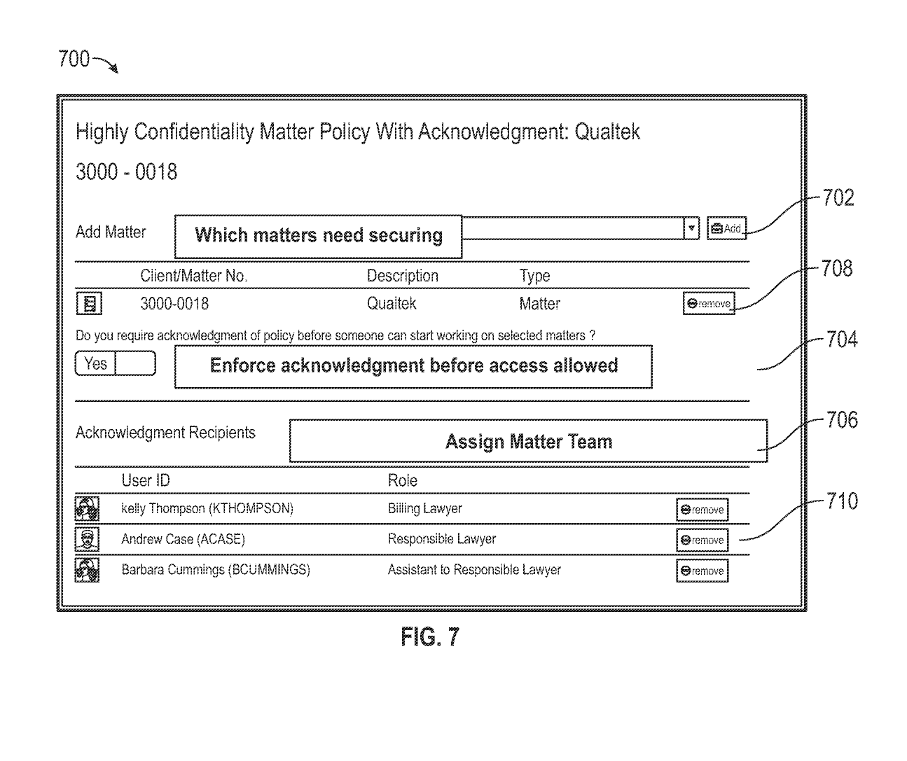

FIG. 7 shows a form 700 for further definition of a Highly Confidential Matter policy. In embodiments, the form 700 may include a user interface element 702 for associating matters which need securing to the policy. Additionally, the form 700 may include a listing 708 of matters already associated to the policy with a user interface element for removing a matter from the policy. The form 700 may also include a user interface element 704 for specifying a requirement for acknowledgement of the policy before access to the policy by a team member is allowed. As shown in FIG. 7, the default option to enforce acknowledgement is automatically selected. Still further, the form 700 may include a user interface element 706 for assigning a matter team. As shown in the example of FIG. 7, matter team members are given as “Kelly Thompson” with the role of Billing Lawyer, “Andrew Case” with the role of Responsible Lawyer (aka the “Matter Owner”) and “Barbara Cummings” with the role of Assistant to the Responsible Lawyer. The form 700 also includes one or more user interface elements 710 for removing matter team members.

Communication of the policy may include questions of:
How are employees informed; and
How communication is monitored.

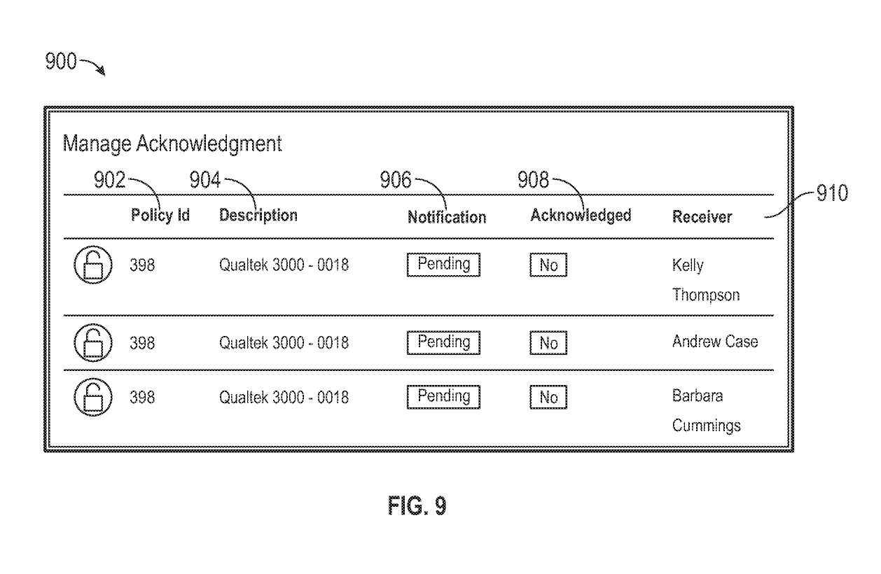

Informing employees of a policy and acknowledgement by employees of receipt of the policy may occur as shown in FIGS. 8 and 9. Shown in FIG. 8 is a template 800 of an email form for informing an employee that he or she has been added to the team, as specified in the relevant policy for a particular document, matter or client. The form is presented to a policy maker upon selecting an option 802 for informing team members. The template contains user interface elements whereby the file/matter/client can be fully identified and a description of the policy provided. Additionally, the template may contain a button or other similar user interface element to confirm acknowledgement by the recipient, for example, by clicking a button, whereupon confirmation of the acknowledgment is returned to the original sender, which is usually, but not always, the policy maker.

Monitoring of communication may occur as shown in FIG. 9, which shows a form for managing acknowledgement of receipt of a policy. The form displays a table that includes columns for:
Policy ID 902;
Policy Description 904;
Notification status 906;
Acknowledgement status 908; and
Receiving party (of the notice) 910.

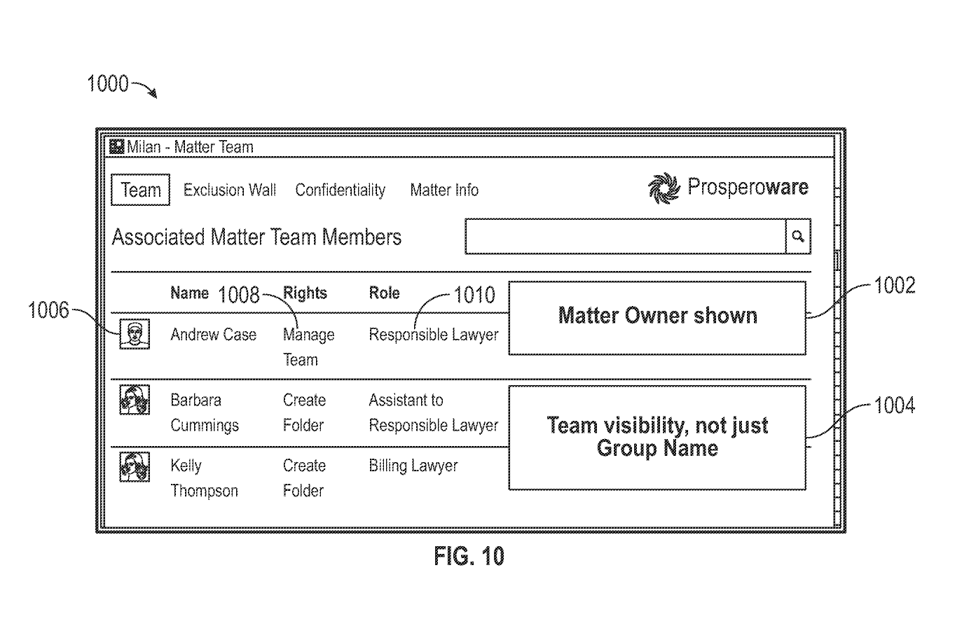

Turning now to FIG. 10, shown is a form for displaying a listing 1004 of the team members associated to a matter. As shown, the Matter Owner, or Responsible Attorney may be prominently displayed 1002. The form may include a table that includes columns for:
Name 1006;
Rights 1008; and
Role 1010.

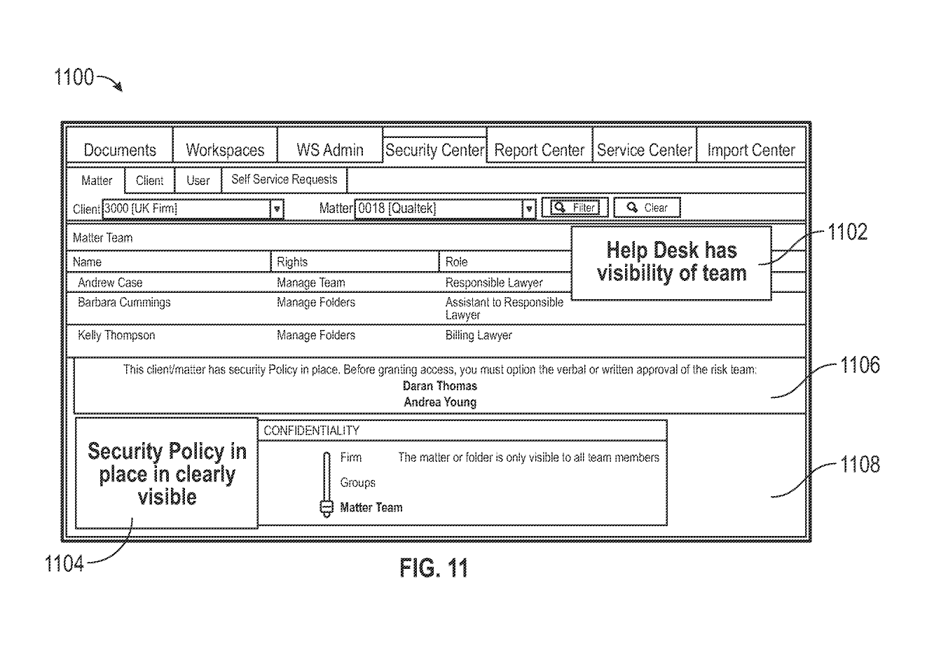

FIG. 11 shows a Security Center record 1100 for a matter, which clearly displays 1104 the security policy in place for the matter. The record 1100 displays a complete listing 1102 of the team, including the Matter Owner, Name, Rights and Role. Additionally, the record lists 1106 the party or parties having authority to approve self-service requests and indicates 1108 the confidentiality level configured for the matter.

### Self-Service Requests

There are matters that require information be confidential due to the risk of insider trading or certain client confidential information such as trade secrets. In this case, the lead professional or matter owner(s) may make the decision as to who may have access to the matter. There are matters that are confidential that require a risk officer to review before granting access. Within the risk management organization, there is the general counsel or chief risk officer, who is the ultimate decision maker.

FIG. 12 shows a diagram of a workflow for making and servicing self-service requests. In order to facilitate providing users with rapid access to matters when required, the users need to be able to request access to a matter through any of several methods: verbally to the Matter owner; verbally to the Service desk; verbally to the Risk Team; and as a self-service request made through a self-service function.

The self-service function may either send out a notification to the appropriate approving authority or may automatically grant the request. The email notification, depending upon the setting, may either inform the authority that someone has been granted access or the notification may inform the authority that a request for access has been made. As shown below, the approving authority may either satisfy the request by, for example, clicking on the button in the email that grants access or by replying with either of the words ‘approved’ or ‘denied.’ Alternatively, the approving authority may call the service desk and provide verbal approval.

In addition to support for self-service requests that grant access to matters via policy, users and administrators may define self-service rules for documents. The self-service rules are designed to allow secretaries for an individual lawyer, document processing center, or outsourced secretarial services to be granted access to a document upon request. The grant of access may be time-limited

The policy engine 410 may receive a request 1204 to access documents and/or matter originated by a requestor 1202. Upon receiving a request 1204, the policy engine 410 may query 1206 the policy database 412 and databases of subsidiary systems, such as the document management system, for content and related policies. If, upon reviewing the policies associated to the requested document or matter, it is found that the user is subject to exclusion from access, the policy engine 410 may refuse 1208 the self-service request. If the policy engine 410 determines that the user is not excluded from access and that the relevant policy or policies allow automated self-service requests 510, 516, the policy engine 410 may forward the request 1204 to the party or parties 402-406, specified in the relevant policies, who are authorized to grant self-service requests. When the request is approved 1214, an email notification 1212 of the approval may be sent to the requestor 1202. A record of the transaction may also be recorded in an audit log 418.

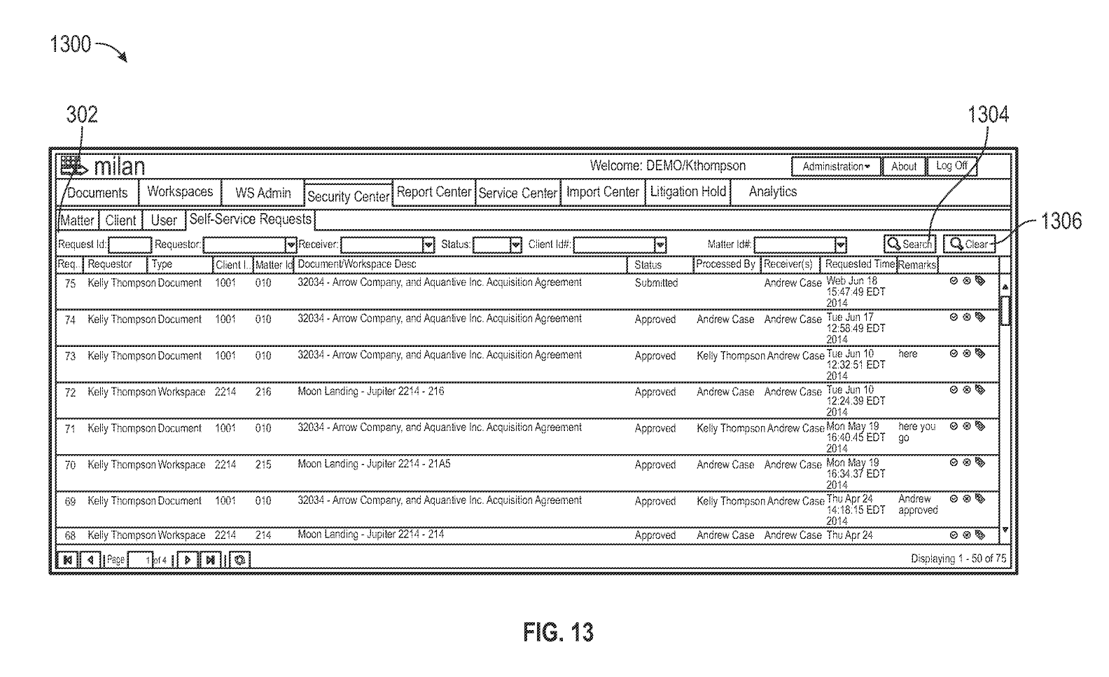

Turning to FIG. 13, shown is a searchable log 1300 of self-service requests that reports the status of each request. In an embodiment, the log 1300 may be a table, wherein the table may have one or more of the following columns:
Request ID;
Requestor;
Client ID;
Matter ID;
Document/workspace description;
Status;
Processed by;
Receiver(s);
Requested time; and
Remarks.

As shown in FIG. 13, the log may include a plurality of search fields that allow users to conduct parametric searches of the self-service request store (not shown). In an embodiment, searchable parameters may include:
Request ID;
Requestor;
Receiver;
Status;
Client ID; and
Matter ID.

In embodiments, the log 1300 may include a ‘search’ button 1304 for launching a search after specifying parameters and a ‘clear’ button 1306 for clearing the parameter fields.

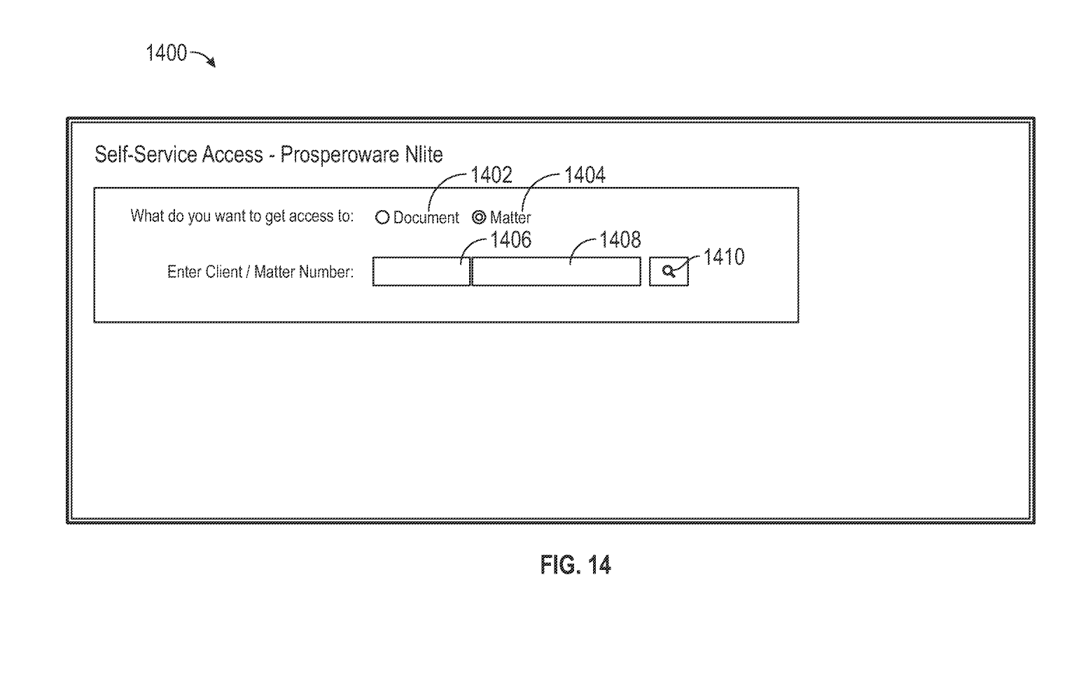

FIG. 14 shows a form 1400 for defining a self-service request. In embodiments, the form 1400 may include user interface elements 1402, 1404 for specifying whether the request is for access to a specific document or for access to a matter. The form 1400 may also include one or more fields for entering client-matter number. The form may also include a ‘search’ button 1410 for launching a search for the desired document and/or matter.

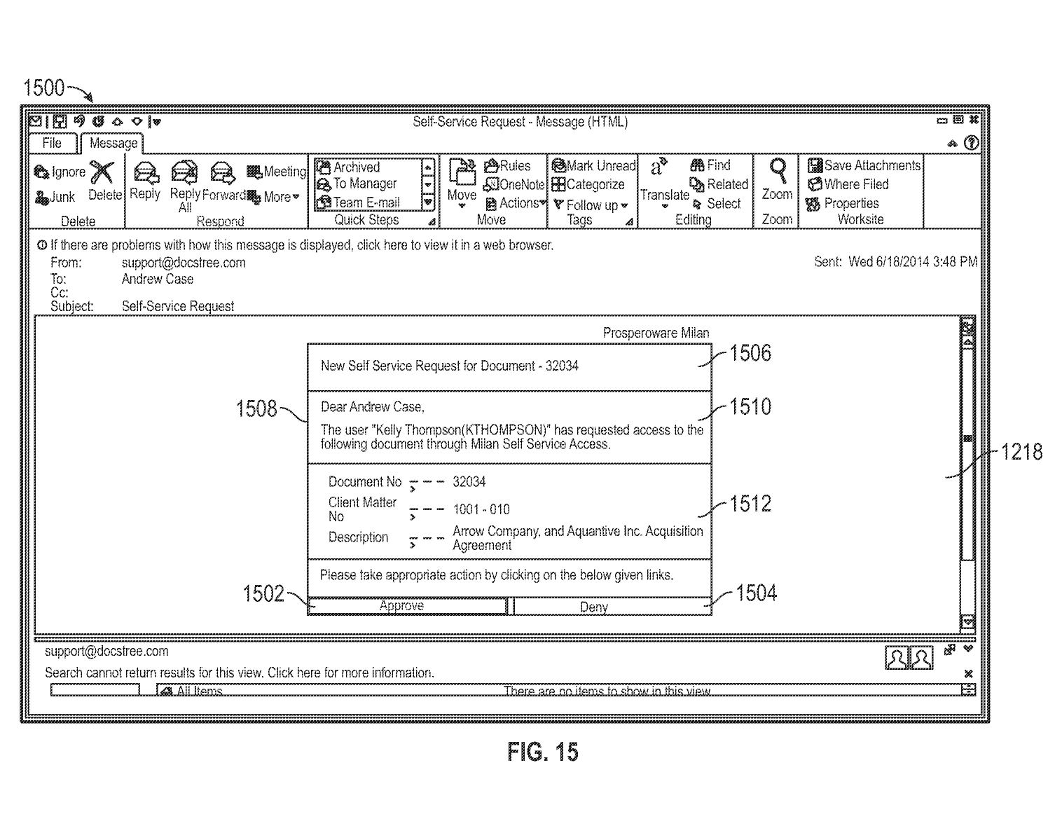

As shown in FIG. 12, the self-service request may be routed to one or more approving authorities by the sending of an email 1218. FIG. 15 shows an email form 1218 for informing an approving authority of the submission of a self-service request. In an embodiment the email 1218 may identify the self-service request by the Request ID 1506 and addresses the recipient 1508. The body of the message 1218 may identify the requestor 1510 and may identify the subject matter of the request by one or more of the document no., the client-matter no. and the description 1512. The approving authority by approve or deny the request by activating either of user interface elements 1502 and 1504. As shown in FIG. 12, the action on the request is reported 1012 to the requestor 1202, for example by email.

As will be understood by those familiar with the art, the methods and system herein described may be embodied in other specific forms without departing from the spirit or essential characteristics thereof. Additionally, the methods and systems may be embodied in a computer program product that includes computer-readable code provided on a non-transitory computer-readable medium. A non-transitory medium does not include ephemeral media such as signals and carrier waves.

Likewise, the particular naming and division of the portions, modules, agents, managers, components, functions, procedures, actions, layers, features, attributes, methodologies, data structures and other aspects are not mandatory or significant, and the mechanisms that implement the systems and methods or their features may have different names, divisions and/or formats. The foregoing description, for purpose of explanation, has been described with reference to specific embodiments. However, the illustrative discussions above are not intended to be exhaustive or limiting to the precise forms disclosed. Many modifications and variations are possible in view of the above teachings. The embodiments were chosen and described in order to best explain relevant principles and their practical applications, to thereby enable others skilled in the art to best utilize various embodiments with or without various modifications as may be suited to the particular use contemplated. The specification and drawings are, accordingly, to be regarded in an illustrative sense rather than a restrictive sense.

1. A computer-implemented method for policy-based confidentiality management comprising:
receiving, by a policy engine on a first computer within an enterprise network, data representing a confidentiality policy, said confidentiality policy comprising at least one rule defining at least one condition for access to at least one data object residing on said enterprise system;
evaluating, by said policy engine, said data representing said confidentiality policy;
responsive to said evaluating, outputting, by said policy engine, data representing computer-readable instructions for implementing said at least one rule defining conditions for access to said at least one data object; and
responsive to said outputting, transmitting said data representing said computer-readable instructions implementing said at least one rule defining conditions for access to said at least one data object to at least one second computer, said at least one second computer comprising at least one of: a computer storing said at least one data resource and a computer attempting to access said data resource; and
responsive to execution of said computer-readable instructions implementing said at least one rule defining conditions for access to said at least one data resource by said at least one second computer, said at least one second computer managing access to said at least one data resource according to said at least one condition for access.

2. The method of claim 1, further comprising:
storing, by said policy engine, said data representing said confidentiality policy in a policy database.

3. The method of claim 2, wherein said policy database comprises a plurality of policy templates.

4. The method of claim 1, wherein receiving said data representing said confidentiality policy comprises at least one of:
receiving data previously stored in a policy database transmitted responsive to a request for access to said policy by said policy engine; and
receiving data representing said confidentiality policy entered by a policymaker.

5. The method of claim 1, wherein said enterprise comprises a professional service organization.

6. The method of claim 1, wherein said at least one data object comprises at least one of:
at least one document;
at least one matter folder;
at least one client folder; and
at least one workspace.

7. The method of claim 1, wherein said at least one condition for access comprises a confidentiality level, wherein said confidentiality level comprises one of more of:
Confidential;
Exclusion;
Inclusion;
Contractor; and
Competitive.

8. The method of claim 1, further comprising:
receiving at said policy engine data representing a self-service request, said self-service request comprising a request from an end user for access to a particular data object
responsive to evaluation of said self-service request by an IT service desk and said at least one confidentiality policy, granting said self-service request by said IT service desk if said self-service request complies with approval criteria specified in said at least one policy, wherein said approval criteria include one or more of:
‘Anyone’, wherein anyone requesting access can be granted access upon request;
‘Approval of Matter Owner’, wherein approval of the matter owner is required to approve any request for access;
‘Approval of Matter Team’, where approval of any member of the matter team can approve access;
‘Approval of Risk Team’, wherein only a Risk Team member can approve any request for access; and
‘No self-service permitted’, wherein access can only be granted by a Risk Team member through a system policy interface.

9. The method of claim 8, further comprising at least one of
enforcing, by said policy engine, said at least one confidentiality policy in systems subsidiary to said enterprise system in real time;
issuing, by said policy engine, at least one report, said at least one report being issued on one of a recurring, a one-time and an occasional basis; and
monitoring, by said policy engine, health of target systems.

10. The method of claim 1, further comprising:
said policy engine transmitting notification to a user of at least one of exclusion from access and inclusion for access to said at least one data object;
responsive to transmitting said notification, said policy engine receiving confirmation of said notification, said confirmation being originated by said user from said at least one second computer, wherein said confirmation is a required condition for access.

11. The method of claim 1, further comprising:
creating, by said policy engine, records of grants and denials of access in an audit log.

12. The method of claim 1, further comprising:
said policy engine overriding native security policies of systems subsidiary to said enterprise system, wherein a native security policy of said enterprise system is implemented in place of said overridden native security policies.

13. The method of claim 12, wherein said subsidiary systems comprise one or more of:
a time and billing system;
at least one SQL system;
a document management system; and
a file-sharing system.

14. The method of claim 1, wherein receiving data representing a confidentiality policy comprises:
receiving data representing at least one grant of access originated by an end user to at least one data object over which said end user has authority to control access.

15. The method of claim 1, wherein said policy engine is capable of supporting at least one of:
multiple policy types;
a risk team; and
roles and responsibilities of members of a matter team.

16. The method of claim 15, wherein said matter team comprises at least one Matter Owner.

17. The method of claim 1, wherein said policy engine is communicatively coupled to a policy application, wherein policymakers enter data representing said at least one confidentiality policy for transmission to said policy engine and wherein end users enter data representing self-service requests for access for transmission to said policy engine.

18. The method of claim 1, wherein said enterprise system comprises at least one global setting defining, at least in part, said at least one condition for access and wherein said confidentiality policy overrides said at least one global setting.

19. A computer program product comprising at least one non-transitory computer-readable storage medium, the at least one non-transitory computer readable medium storing program code that, when loaded into computer memory and executed by a processor performs the following steps:
receiving, by a policy engine on a first computer within an enterprise network, data representing a confidentiality policy, said confidentiality policy comprising at least one rule defining at least one condition for access to at least one data object residing on said enterprise system;
evaluating, by said policy engine, said data representing said confidentiality policy;
responsive to said evaluating, outputting, by said policy engine, data representing computer-readable instructions for implementing said at least one rule defining conditions for access to said at least one data object; and
responsive to said outputting, transmitting said data representing said computer-readable instructions implementing said at least one rule defining conditions for access to said at least one data object to at least one second computer, said at least one second computer comprising at least one of: a computer storing said at least one data resource and a computer attempting to access said data resource; and
responsive to execution of said computer-readable instructions implementing said at least one rule defining conditions for access to said at least one data resource by said at least one second computer, said at least one second computer managing access to said at least one data resource according to said at least one condition for access.

20. A computer system for policy-based confidentiality management comprising:
computer memory;
at least one processor;
a policy engine residing in the computer memory, configured for:
receiving on a first computer within an enterprise network, data representing a confidentiality policy, said confidentiality policy comprising at least one rule defining at least one condition for access to at least one data object residing on said enterprise system;
evaluating said data representing said confidentiality policy;
responsive to said evaluating, outputting data representing computer-readable instructions for implementing said at least one rule defining conditions for access to said at least one data object; and
responsive to said outputting, transmitting said data representing said computer-readable instructions implementing said at least one rule defining conditions for access to said at least one data object to at least one second computer, said at least one second computer comprising at least one of: a computer storing said at least one data resource and a computer attempting to access said data resource;
responsive to execution of said computer-readable instructions implementing said at least one rule defining conditions for access to said at least one data resource by said at least one second computer, said at least one second computer managing access to said at least one data resource according to said at least one condition for access.
